(19) United States
(12) Patent Application Publication
(10) Pub. No.: US 2007/0052225 A1
(43) Pub. Date: Mar. 8, 2007

(54) Method of packaging an air-bag

(76) Inventors: Jacobsson Borje, Bramhult (SE); Jaconelli Hakan, Alingsas (SE)

Correspondence Address: BRINKS HOFER GILSON & LIONE, P.O. BOX 10395, CHICAGO, IL, 60610, US

(21) Appl. No.: 10/554,214

(22) PCT Filed: Apr. 22, 2004
(86) PCT No.: PCT/EP04/04289

§ 371 Date: Oct. 16, 2006

(30) Foreign Application Priority Data
Apr. 24, 2003 (GB) GB 0309306.9

(51) Int. Cl. B60R 21/16

(52) U.S. Cl. 280/743.1

(57) ABSTRACT

A method of packaging an air-bag including the steps of folding the air-bag into a roll (1, 10), deforming the roll (1, 10) to have at least a region having a substantially “C” shape, and packaging the deformed roll (1, 10). The roll (1, 10) is preferably deformed by urging a member (4, 12) into contact with the exterior of the roll (1, 10). This member can be in the form of objects including a rod or axle (4), or a plate (12).

### CROSS REFERENCE TO RELATED APPLICATIONS

This application claims priority to Great Britain patent application 0309306.9, filed Apr. 234, 2003 and PCT/EP2004/004289, filed Apr. 22, 2004.

### FIELD OF THE INVENTION

The present invention relates to method of packaging an air-bag and more particularly relates to a method of packaging an air-bag such as an inflatable curtain.

### BACKGROUND OF THE INVENTION

It has been proposed to provide an air-bag in a motor vehicle in the form of an inflatable curtain. The air-bag is initially stored in the roof lining (or headliner) of the motor vehicle above the door openings and, in the event that an accident should occur, is inflated to form a curtain which extends between the head of a vehicle passenger and the adjacent window. Many vehicles are provided with inflatable curtain air-bags of this type.

It has been proposed to package an inflatable curtain of this general type, either by rolling the air-bag to form a generally cylindrical roll and then inserting the roll into an appropriate package or, alternatively, to fold the air-bag using, for example, zig-zag folds and then providing a package for the folded air-bag. The resultant packages tend to be cylindrical, and it is often difficult to provide sufficient space within the roof lining of a motor vehicle to receive a package of this particular format. In many cases, it is preferable to have a rectangular package due to the shape of the roof lining.

The present invention seeks to provide an improved method of packaging an air-bag in the form of an inflatable curtain.

Accordingly, the present invention provides a method of packaging an air-bag in the form of an inflatable curtain, the method including the steps of folding the air-bag into a roll, deforming the roll such that at least a region of the roll has a substantially “C” shape, and packaging the deformed roll.

Preferably, the roll is deformed so as to have a plurality of substantially “C” shaped regions.

Advantageously, the roll is deformed by urging a member into contact with the exterior of the roll.

Conveniently, the roll is deformed by a plurality of the members.

Advantageously, the member urged into contact with the exterior of the roll is a rod or axle. Conveniently, the roll is introduced to the package together with the rod or axle and the rod or axle is subsequently withdrawn from the package.

Preferably, the member urged into contact with the roll is a plate, there being a substantially “U” shaped form to receive the roll. Advantageously, the plate is removed from the combination of the deformed roll and the form, the combination of the deformed roll and the form is introduced to a package, and finally the “U” shaped form is withdrawn from the package.

Conveniently, the package is formed so as to have a substantially rectangular form.

Preferably, the package is formed such that the major axis of the substantially “C”-shaped region lies substantially parallel to the longitudinal axis of the rectangular package.

Alternatively, the package is formed such that the major axis of the substantially “C”-shaped region lies substantially perpendicular to the longitudinal axis of the rectangular package.

The present invention also provides an air-bag packaged by methods described herein.

### BRIEF DESCRIPTION OF THE DRAWINGS

In order that the invention may be more readily understood, and so that further features thereof may be appreciated, embodiments of the invention will now be described, by way of example, with reference to the accompanying drawings in which:

FIG. 1 is a diagrammatic view illustrating a first stage in the packaging of an air-bag in accordance with this invention;

FIG. 2 illustrates a subsequent stage;

FIG. 3 illustrates a further stage;

FIG. 4 illustrates a final stage;

FIG. 5 illustrates the first stage of an alternate method of packaging an air-bag in accordance with this invention;

FIG. 6 illustrates a subsequent stage;

FIG. 7 illustrates a further stage;

FIG. 8 illustrates a final stage;

FIG. 9 is a diagrammatic view illustrating a modified method of packaging an air-bag in accordance with this invention;

FIG. 10 illustrates a subsequent stage;

FIG. 11 illustrates a further stage;

FIG. 12 illustrates a final stage; and

FIG. 13 illustrates an alternative form of air-bag produced by the method of the present invention.

### DETAILED DESCRIPTION OF THE INVENTION

The methods of packaging an air-bag which will be described below seek to achieve a package which is of generally oval or rectangular form, thus facilitating the location of the package within the roof lining of a motor vehicle.

Considering initially FIGS. 1 to 4, a method of packaging an air-bag will be described in which the air-bag is rolled and then formed so that at least a region of the air-bag has a generally “C” shape, thus providing an enhanced package.

FIG. 1 illustrates diagrammatically an air-bag 1 which has been rolled to have a cylindrical form, such that only part of the air-bag in form of mounting lugs 2 extends from the roll. A sheet-like wrapper 3 is illustrated in which the rolled air-bag is to be packaged. Shown adjacent the air-bag is a rigid rod or axle 4.

FIG. 2 illustrates the rod or axle 4 being moved forcibly towards the centre of the roll 1. The outer part of the roll 1 may be prevented from movement by an appropriately shaped housing or retainer element, but the effect of the rod or axle 4 is to deform the roll 1 from its initial cylindrical shape, as shown in FIG. 1, to have a substantially “C” shape as shown in FIG. 2.

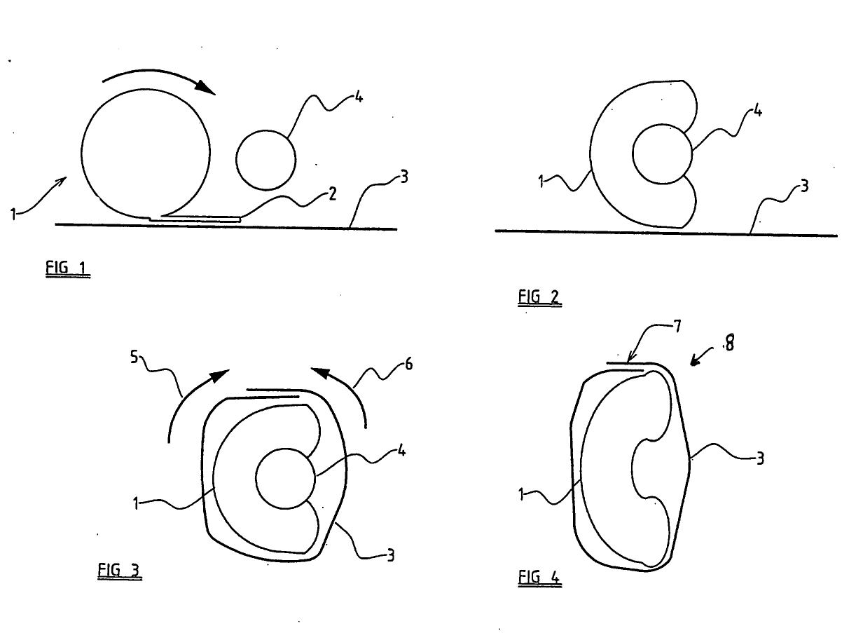

FIG. 3 shows the wrapper 3 being moved upwardly, as indicated by arrows 5 and 6 on either side of the combination of the air-bag 1 forced into a “C” shaped roll and the rod or axle 4, to form a package. The rod or axle 4 is then removed from the package, and the wrapping 3 is secured together in the region 7 to form a complete package. It is to be observed that the complete package 8 is of generally oval form. However, it is also envisaged that the package 8 could take a generally rectangular form.

It is envisaged that an air-bag 1 which, when rolled in the form of a roll as shown in FIG. 1 so as to have an outer diameter of 4 cm may, by the described technique, be presented in a generally oval or rectangular package having a maximum dimension in the range of 4-5 cm and a minimum dimension in the range of 2 2.5 cm. Such a package 8 may be more easily retained within a roof lining of a motor vehicle.

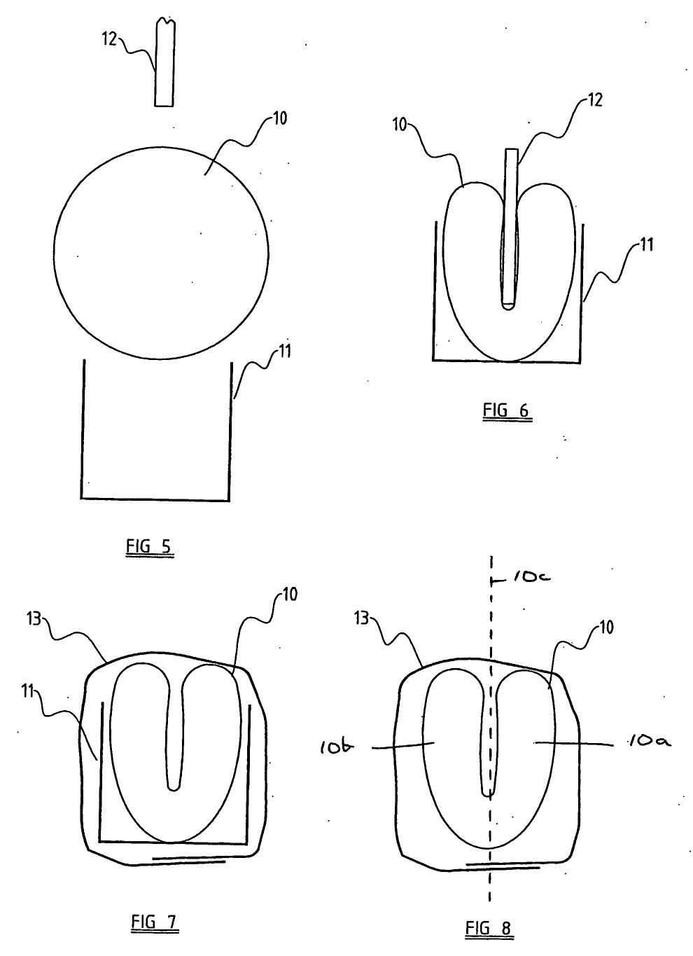

FIGS. 5 to 8 illustrate an alternative method of packaging an air-bag, also in accordance with the invention. Referring initially to FIG. 5, a rolled air-bag 10, equivalent to the air bag 1 of FIG. 1, is illustrated. Also shown is a “U” shaped form 11 and a deforming plate 12 located above the rolled air-bag. The air-bag 10 is located on top of the form 11, and the deforming plate 12, as shown in FIG. 6, is moved forcibly downwardly in alignment with the centre line of the form 11. The end result is that the roll 10 is forced into the form 11, with the roll having one part on one side of the plate 12 and another part on the other side of the plate 12. The roll thus adopts a generally “C” shaped configuration within the “U” shaped form 11. Subsequently, as shown in FIG. 7, the plate 12 is removed and a wrapper or packaging 13 may be passed around the combination of the roll 10 and the form 11. Finally the form 11 is removed from the package and the package 13 is sealed as shown in FIG. 8, so as to have a generally rectangular form.

It is to be appreciated that in both of the methods described above the final package consists of a roll which has been deformed to be of “C” shape contained within a package. In the arrangement of FIG. 8, it will be seen that the two limbs 10a, 10b of the “C”-shaped roll extend so as to lie substantially parallel to the long sides of the rectangular package 13, such that the gap therebetween is directed towards the short side of the rectangular package. The “C”-shaped roll can therefore be considered to be oriented such that its major axis lies substantially parallel to the longitudinal axis of the rectangular package.

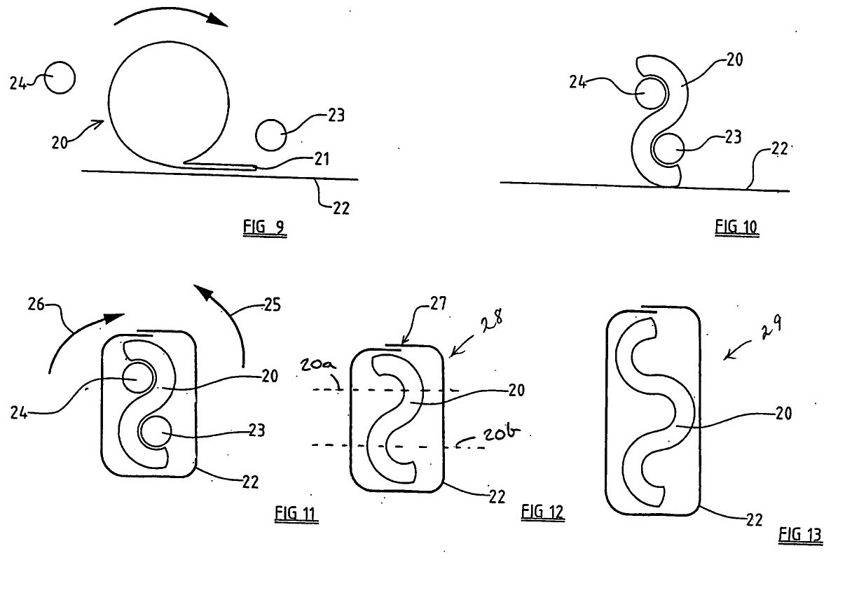

However, it is also envisaged that variants of the methods described above could be used to produce a final air-bag package in which the rolled air-bag is deformed so as to have a plurality of substantially “C” shaped regions. In this regard, reference will now be made to FIG. 9 to 12.

Referring initially to FIG. 9, a rolled air-bag 20, equivalent to the air-bag 1 of FIG. 1, is illustrated. The air-bag 20 has been rolled so as to have a generally cylindrical form, such that only part of the air-bag in the form of mounting lugs 21 extends from the roll 20. A sheet like wrapper 22 is again illustrated, in which the rolled air-bag 20 is to be packaged. Showing adjacent the air-bag 20, on opposite sides of the air-bag are two rigid rods or axles 23 and 24. The two rods or axles 23 and 24 are offset from one another, such that the first rod or axle 23 is located nearer to the wrapper 22 while it lays flat than the second rod or axle 24.

FIG. 10 illustrates the two rods or axles 23 and 24 having been moved forcibly towards one another as to deform the roll 20. It will therefore be seen that the effect of the two rods or axles 23 and 24 is to deform the rolled air-bag 20 from its initial cylindrical shape, as shown in FIG. 9, so as to have a substantially serpentine or “S” shape as shown in FIG. 10. In fact, it will be seen that the deformed roll actually has a pair of opposed “C” shaped regions, each “C” shaped region being formed by a respective rod or axle 23, 24.

FIG. 11 shows the wrapper 22 being moved upwardly, as indicated by arrows 25 and 26 on either side of the combination of the shaped roll 20 and the rod or axles 23 and 24, to form a package in substantially the same way as described above in connection with FIG. 3. The rod or axles 23 and 24 are then both removed from the package and the wrapper 22 is secured together in the region 27 to form a complete package. It is to be observed that the complete package 28 again has a generally rectangular form. However, in this configuration, in context to that of FIG. 8, the major axes 20a and 20b, of each “C”-shaped region lie substantially perpendicular to the longitudinal axis of the rectangular package 28.

It should be appreciated that the method described above in connection with FIGS. 9 to 12 could be modified so as to form a completed air-bag package in which the roll 20 has more that two substantially “C” shaped regions. For example, FIG. 13 illustrates an alternative package in which the roll 20 has three opposed substantially “C” shaped regions. This type of package 29 can simply be formed by a variation of the method described above in connection with FIGS. 9 to 12, but using three rods or similar to axles 23 and 24.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. A method of packaging an air-bag in the form of an inflatable curtain, the method comprising the steps of folding the air-bag into a roll, deforming the roll such that at least a region of the roll has a substantially “C” shape, and packaging the deformed roll in a package.

2. A method according to claim 1, wherein the roll is deformed so as to have a plurality of substantially “C” shaped regions.

3. A method according to claim 1, wherein the roll is deformed by urging at least one member into contact with the exterior of the roll.

4. A method according to claim 3, wherein the roll is deformed by a plurality of the members.

5. A method according to claim 3, wherein the member urged into contact with the exterior of the roll is a rod or axle.

6. A method according to claim 3, the member is in contact with the deformer roll during the stage of packaging, and the member is subsequently withdrawn from the package.

7. A method according to claim 3, wherein the member urged into contact with the roll is a plate, there being a substantially “U” shaped form to contact and receive the roll.

8. A method according to claim 7, wherein the plate is removed from the combination of the deformed roll and the form, the combination of the deformed roll and the form is introduced to a package, and finally the “U” shaped form is withdrawn from the package.

9. A method according to claim 1, wherein the package is formed so as to have a substantially rectangular form.

10. A method according to claim 9, wherein the package is formed such that the major axis of the “C”-shaped region lies substantially parallel to the longitudinal axis of the rectangular form package.

11. A method according to claim 9, wherein the package is formed such that the major axis of the “C”-shaped region lies substantially perpendicular to the longitudinal axis of the rectangular package.

12. A method according to claim 1 wherein the step of packaging the deformed roll includes wrapping a wrapper around the roll and securing the wrapper to retain the deformed roll into the package.
